(19) United States
(12) Patent Application Publication
(10) Pub. No.: US 2016/0374348 A1
(43) Pub. Date: Dec. 29, 2016

(54) POLYMER-SUPPORTED ANTIMICROBIAL COMPOSITES AND METHODS OF USING THE SAME

(71) Applicant: Deringer-Ney, Inc., Bloomfield, CT (US)

(72) Inventors: Sherman Ponder, Bloomfield, CT (US); Edward Smith, Bloomfield, CT (US)

(21) Appl. No.: 14/752,339

(22) Filed: Jun. 26, 2015

(51) Int. Cl. A01N 59/16; A01N 25/10

(52) U.S. Cl. CPC A01N 59/16; A01N 25/10

(57) ABSTRACT

An antimicrobial composite includes a polymeric support and at least one transition metal mounted onto the support surface. The transition metal may be silver, and the support material may be a non-reactive plastic such as polyethylene or polypropylene. The composite may be encapsulated by a permeable or porous outer layer. Preparation of the composite may involve mixing an aqueous salt solution containing the transition metal with the support in the presence of a surfactant, precipitating the metal onto the support, and reducing the metal to its elemental state. The resulting composite in which the polymeric support surface includes the elemental metal is useful in the treatment of water and ice to inhibit or prevent microbial growth.

### TECHNICAL FIELD

The present disclosure relates to an antimicrobial composite including at least one transition metal coupled to the surface of a polymeric support, methods of making the composite, and methods of using such composites. The composite exhibits strong antimicrobial properties when in contact with water.

### BACKGROUND

Silver is known to have strong antimicrobial properties at concentrations that pose no direct threat to human health. The antimicrobial property of silver is due to its redox properties. Silver further has a high first ionization energy (730.8 kJ/mol). The half-reaction of silver can be represented as:

Ag⁺+e⁻→Ag⁰ E₀=0.7996 v (I)

The positive E₀ means that the reduction is spontaneous, but that the oxidation of the metal requires a substantial input of energy. The high voltage of the E₀ translates to silver ions having the oxidizing power equivalent to that of household bleach (NaOCl):

OCl⁻+H₂O+2e⁻→Cl⁻+2OH⁻ E₀=0.81 v (II)

Since ionic silver is spontaneously reduced, it can serve as a highly active oxidant of a biological system under water treatment conditions.

In living organisms, peptidoglycans and glycosaminoglycans are readily available as target reducing molecules. These molecules are composed primarily of reducing sugars joined by β1→4 linkages.

In eukaryotes, the outer membrane of the cell is composed of a phospholipid bilayer. The phospholipid bilayer mediates ingress and egress to the cell body. While there is a relatively small amount of (primarily entropic) energy involved to bind the molecules of the phospholipids together, phospholipid bilayers do not have structural integrity. Further, phospholipids are fully oxidized and thus do not react with ionic silver.

Individual cells in eukaryotes are surrounded by a type of support structure called the extracellular matrix which holds groups of cells together. This matrix is composed of glycosaminoglycans, or proteoglycans which are connected through an amide bond to extracellular proteins. Glycosaminoglycans are heteropolysaccharides composed of repeating disaccharide units, most commonly hyaluronate, chondroitin sulfate, and keratan sulfate. These molecules form highly viscous clear solutions, and, while found throughout the organism as structural matrices, are particularly prominent in the synovial fluid of joints and the vitreous humor of the eye.

Since the extracellular matrix surrounds the eukaryotic cells, ionic silver reacts with the polysaccharides of the extracellular matrix prior to contact with the cell membranes. All of the polysaccharides found in the extracellular matrix are composed of reducing sugars with β1→4 or β1→3 linkages. These linkages can be severed by oxidation to the aldehyde or the carboxylic acid (derivatives of the component sugars). Thus, in multi-celled animals, ionic silver is reduced and typically deposited as an insoluble solid within the extracellular matrix before it contacts the cell membrane. Nano- or picodeposition of silver within the extracellular matrix is the likely cause of argyria, the permanent, but non-pathogenic, blue-gray discoloration of tissue resulting from prolonged or acute contact with Ag+.

Single celled organisms, in general, do not have an extracellular matrix, although there are notable bacterial exceptions that do produce a capsule or loose slime outside the cell wall. In most cases, Ag+ will react directly with molecules present in the prokaryotic cell membrane. This direct redox action with the primary structural components of the prokaryotic cell attributes to silver's antimicrobial action.

There are two major classes of bacteria, gram negative and gram positive, historically named for the degree of coloration obtained by the use of crystal violet and iodine as a biological stain. Both types of bacteria use peptidoglycans as the structural component to form the cell membrane and to maintain integrity of the organism. Peptidoglycans are unique to prokaryotes, and gram positive bacteria have a significantly thicker layer of peptidoglycans than do gram negatives.

Although both classes of bacteria have an inner cell membrane of phospholipid bilayer, prokaryotic cells such as bacteria rely on the rigid peptidoglycan layer for structural integrity. The peptidoglycan normally consists of a heteropolymer of alternating N-acetylglucosamine and N-acetylmuramic acid. In gram positive species, the glycan strands are strongly cross-linked with short chains of amino acids, while the cross-linkage is much looser in gram negative bacteria. The exact amino acids in the crosslinks vary between species of bacteria.

As noted, Ag+ is reduced to Ag0 in multi-cellular organisms by reacting with the heteropolysaccharides in the extracellular matrix. But when Ag+ contacts prokaryotic cells, it reacts with the glycosidic bonds that hold the peptidoglycan layer together. The most reactive bond on the heterosaccharide backbone is believed to be between the 1st carbon of N-acetylmuramic acid and the glycosidic oxygen. This is the bond attacked by biological enzymes, such as lysozyme, and oxidation from Ag+ contact likely occurs at this bond. The effect of oxidation at this bond is the rupture of the polysaccharide strand.

The rupture of the strands of the proteoglycan layer destroys the major component of prokaryote cellular structural integrity. Many prokaryotes actually can survive the loss of the proteoglycan layer, although they lose their typical shape and tend to form roughly spherical protoplasts. However, cells stripped of their proteoglycan rigidity are highly susceptible to osmotic variations. Thus, a stripped cell might survive without too much difficulty in still water of equal osmotic pressure, but is unlikely to survive in flowing water, or in water with lower osmotic pressure than the cytoplasm, such as drinking water, or in locations where the cell is alternately wetted and dried.

Finally, even if a prokaryote cell survives the destruction of its proteoglycan layer, Ag+ has another mode of attack against prokaryotes. Because prokaryotes have no nucleic membrane, Ag+ is able to access and oxidize the DNA in prokaryotes. While the exact effect of silver ions on DNA is not known, various opportunities for DNA oxidation include deamination, depurination, and even possibly, oxidation of the deoxyribose sugar. Ionic silver is capable of binding to free and denatured DNA. Ionic silver has not been seen to bind to eukaryotic DNA in vivo.

Thus, while Ag+ is capable of rupturing and destroying prokaryotic DNA, it is not seen to be capable of accessing eukaryotic DNA. Destruction of prokaryotic DNA inhibits or prevents bacterial reproduction. While this Ag+ action is of secondary importance with most microorganisms, it is primary for rare genuses, such as Mycoplasma, that does not have a proteoglycan layer.

When presently used in the treatment of water supplies, silver and/or other metals are mounted onto alumina supports, primarily by dehydration or impregnation. Such processes, however, require considerable heat expenditure and are costly to prepare. In addition, the agostic bonds typically formed during such high temperature processes between the alumina and the metal create inconsistent quality issues from one batch to another.

### SUMMARY

Implementations provide antimicrobial composites useful in the treatment of water and ice.

In one exemplary implementation, an antimicrobial composite includes particulates of at least one transition metal coupled to a polymeric support.

In another exemplary implementation, a method of preparing an antimicrobial composite with at least one transition metal mounted onto a polymeric support involves mixing an aqueous solution of a salt of a transition metal and a surfactant with the polymeric support; precipitating the transition metal onto the polymeric support; reducing the precipitated transition metal to the elemental state of the metal; and removing moisture to provide the polymeric support with transition metal particulates.

### BRIEF DESCRIPTION OF THE DRAWINGS

FIGS. 1-3 are photographs of silver particles on a polymeric support taken from a scanning electron microscope (SEM).

### DETAILED DESCRIPTION

### Overview

Antimicrobial composites of the present disclosure may include a polymeric support and at least one transition metal mounted onto the support, such as silver particulates in the form of nanoparticles or fine particles. Portions of the transition metal may be coated with a protective layer in order to provide a timed-release of the transition metal in delivering its antimicrobial properties. The polymeric support material may be any polymeric organic, including co-polymers, in solid phase at room temperature. The composites of the present disclosure may be encompassed by a permeable or porous outer layer, such as a mesh bag or sachet, such that free-flowing water may contact the composite and enable the composite to provide an antimicrobial treatment to the water.

The composite can treat bulk water, as well as the splash zones and traverse regions of a water supply or reservoir, which may be susceptible to microbial growth and slime formation. The composite may be used to prevent and control microbial growth.

The antimicrobial composite of the present disclosure may provide a constant, small supply of solubilized metal ions that are introduced into the water supply or water reservoir being treated. Upon contact of the metal ions with microbial cell walls (and possibly microbial DNA), the metal ions are reduced to the elemental metal, while the process of oxidation of the microbial peptidoglycans destroys the structural integrity of the cell walls and the cell entirely, somewhat analogous to the antimicrobial actions of some antibiotics, e.g., penicillin. The initial release of the metal ions results in their dispersal throughout the water, and entrainment of the ions in the water droplets that are splashed onto the splash and traverse zones around the water reservoir further extends the dispersal of the ions and oxidizable metals throughout the entire interior of the equipment to be treated.

According to certain implementations, the antimicrobial composite may be prepared by a one-pot synthesis procedure. The process of making the composite may be performed at low heat (generally less than 100° C.). This process provides better efficacy and lower leach rate compared to other supported transition materials, such as those supported on alumina, granulated activated carbon, or calcium phosphate. At the same time, the process results in a material that is hydrophilic on its surfaces and that can be readily wetted when contacted with water, even though the polymeric supports are typically hydrophobic.

### Antimicrobial Composite—Transition Metal:

The antimicrobial composites of the present disclosure include at least one transition metal mounted onto a polymeric support. Metals that may be present in the antimicrobial composite include but are not limited to Ag, Cr, Co, Ti, V, Mn, Ni, Cu, and Zn and mixtures thereof. According to certain implementations, silver may be the preferred metal and may provide from about 25 to about 100 weight percent, preferably greater than 50 weight percent, of the transition metal mounted onto the polymeric support, as a percentage of metal content in the preferred embodiment. In some implementations, the transition metal of the antimicrobial composite may consist only of silver.

The metal(s) may be deposited onto the support through, for example, precipitation. The metal particulates may range from nanoparticles to fine particles. The metal particle size may be, for example, about 50 nm to about 400 nm; about 50 nm to 300 nm; about 50 nm to 200 nm; about 75 nm to about 400 nm; about 75 nm to about 300 nm; about 75 nm to about 200 nm; about 100 nm to 400 nm; about 100 to 200 nm; or about 175 nm+/−75 nm.

The metal particles of the antimicrobial composite may be coated with or bound to a composition that facilitates in the slow-release of the metal ion to increase the longevity of the antimicrobial effects of the antimicrobial composite. As provided further herein, the coating may include, but is not limited to, an R-silane coupling, an R-quaternary ammonium coupling, an R-phosphonate coupling, an R-sulfonate coupling, or an R-carboxylate coupling. The R group for these couplings may be an alkyl or alkene moiety, which can range from a methyl group up to and including an octadecyl group, branched or unbranched. In some implementations, a silane coupling may be preferred as the coating composition. The coating may protect a portion of the metal particle while leaving another portion of the particle exposed or unhindered. In one example in which silane is used as a coating, the metal, such as silver, may be sequestered through steric hindrance provided by the oxygen of the silane binding to and occluding a portion of the silver atoms on the metal particle while leaving other atoms exposed. This enables the partially coated or covered metal particle to provide antimicrobial properties at the exposed surface area, leaving the protected area of the particle unaffected. As the metal at the exposed area is depleted over time, the underlying metal becomes exposed, giving the previously protected metal the ability to provide antimicrobial properties. As a result, the coated or bound metal particle may serve as a slow-release particle that may provide longevity to the antimicrobial composite.

### Antimicrobial Composite—Polymeric Support:

The polymeric support of the antimicrobial composite may be any polymeric organic in solid phase at room temperature. Homopolymers as well as copolymers are acceptable. The polymeric support may be configured as discrete particles and may be provided in the form of a powder, pellets, strips, shreds flakes or granules. The granules may be ground from pellets.

The support may have a melting point of from about 86° C. to about 300° C.; or about 90° C. to about 170° C. An average particle diameter of the support may be about 0.5 μm to about 2.5 cm. Particle diameter size and dimension may be generally related to the intended application and also to the required flow (gpm) of the particular use. According to certain implementations, the support particle diameter between about 0.5 and about 4.0 mm may be preferred According to certain implementations, the support particle diameter between 0.4 mm and 1.0 mm may be preferred. In some implementations, the exterior of the support may be rough and irregular, rather than smooth, with crenellations in excess of 1 μm per 50 μm. The rough and/or irregular exterior may provide increased surface area onto which metals can be deposited or precipitated according to the present disclosure. The support may be a non-reactive plastic, such as polypropylene or polyethylene.

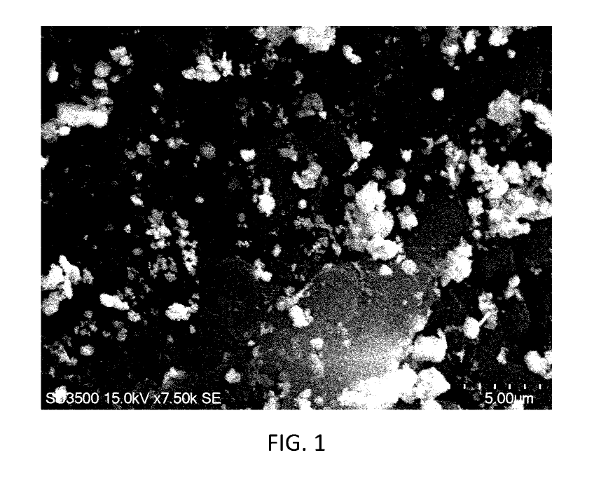

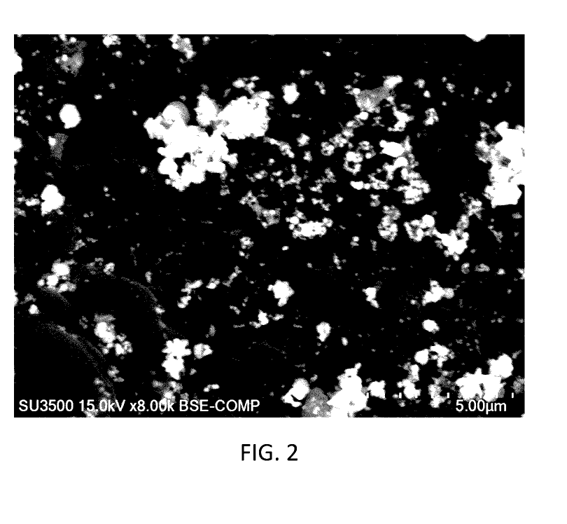

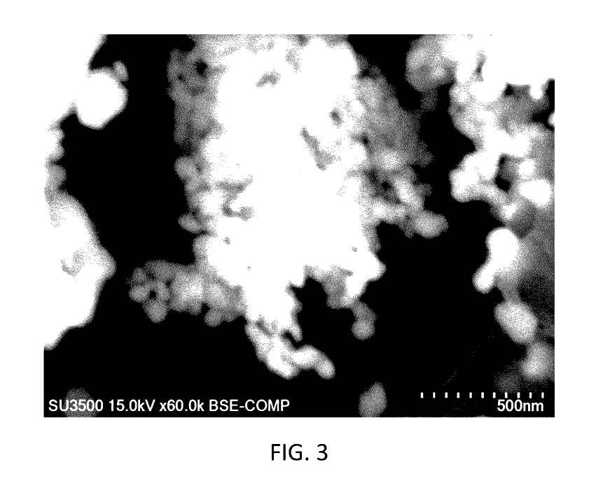

FIGS. 1-3 are images of silver particles on a polymeric support taken from a scanning electron microscope (SEM). The silver particles of FIG. 1 are not coated with carbon, a type of coating commonly used for sample preparation prior to SEM imaging to lower electrical charging, while the silver particles of FIGS. 2 and 3 are carbon coated. The particles are held to the support primarily by van der Waals forces, which are relatively weak electric forces that attract the metal particulates to the polymeric support exterior. Particles such as those depicted in FIGS. 1-3 may be precipitated onto the support according to methods of the present disclosure. Where the metal particles, or a portion thereof, are coated or partially coated with one or more of the coatings of the present disclosure (e.g., an R-silane), the particles may continue to be coupled to the support by van der Waals forces, and additionally or alternatively, may be coupled to the support via the coating. Particularly, the coating may bind to both the exterior surfaces of the particle and the support.

### Antimicrobial Composite—Optional Outer Layer:

The antimicrobial composite may optionally be encased by an outer permeable layer, such as a meshed layer including but not limited to a mesh bag or sachet. The outer layer may be composed of any material as long as the layer is permeable to water. For instance, the outer permeable layer may be composed of paper or cloth as well as plastic containing pinholes. As such, the antimicrobial composite may be contained within a defined area such that water penetrates and passes freely through the outer layer, while the composite material is prevented from spreading throughout the treated water reservoir. Thus, the pore size of the permeable layer may be dependent upon the size of the support of the antimicrobial composite, where the diameter of the pores or holes of the outer layer are dependent and smaller than the diameter of the support of the antimicrobial composite.

In some exemplary embodiments, the outer layer may be formed by melting or sealing one or multiple sheets of porous, nonwoven, pressed or meshed fabric, plastic or fiber at its ends and edges. In one example, the outer layer may be a mesh of plastic such as polyester. As a result, all sides of the outer layer may be sealed together. The outer layer may further be a slatted or screened device or container which may be composed of a variety of materials, such as polyethylene. The antimicrobial composite forms the inner layer surrounded by an outer porous layer. Such products may contain the mesh “envelope” directly adjacent to the antimicrobial composite. The slatted or screened device may be manufactured in a variety of materials, such as high density polyethylene (HDPE) and may be manufactured in a wide variety of shapes or configurations. For instance, the antimicrobial composite may be contained within one or more permeable or porous containers or devices that allow flow of water into and out of the container or device, but restrict the exit of the antimicrobial composite from the container or device.

### Antimicrobial Composite—Production:

The antimicrobial composite may be prepared by a one pot synthesis under mild synthesis conditions. Such mild conditions, often referred to as chemie douce, reduce the cost of synthesis since high energy expenditure and costly and dangerous harsh agents are not used. The process involves mixing an aqueous solution containing a salt of the transition metal(s) and surfactant with the polymeric support. An aqueous solution containing a precipitating salt is then added to the mixture. The resulting supported precipitate composite is then dried in an oven to evaporate any water present. The metal(s) on the dry, supported composite is then reduced to elemental metal(s) by the addition of an aqueous solution containing a reducing agent. The resulting supported metal/plastic composite may then be washed, rinsed, decanted, filtered, and/or dried in an oven to remove excess water.

Prior to precipitation, the transition metal may be in the form of a water soluble salt of the transition metal, such as a nitrate, fluoride, perchlorate or chlorate. Nitrate salts may be preferred. Mixtures of metal salts may further be employed. For instance, use of silver nitrate salt may be substituted with a transition metal, such as zinc, copper, vanadium, cobalt, iron or nickel. The substituted metal may preferably be copper or zinc. The degree of substitution of the silver metal may range from about 0.01 to about 75.0 mole percent. The final silver content in the antimicrobial composite can range from about 0.01% to about 9.9% w/w; about 0.03 to about 4.93 w/w, or preferably from about 0.09 to about 2.45% w/w.

During production, an aqueous solution of surfactant may be added to the aqueous metal salt solution, for instance, in a 0.06 to 100% w/w ratio of active ingredients, relative to the aqueous metal salt solution. In some implementations, the surfactant to salt ratio may be about 0.2 to about 8.0% w/w; or about 0.6 to about 8.0% w/w may be preferred. The surfactant may be any amphiphilic molecule with a hydrophobic head group and hydrophilic tail, preferably an aliphatic chain. Amphiphilic surfactants are characterized by the critical micelle concentration (CMC), which is the minimum concentration for the surfactant to form complete micelles. Amphiphiles are furthermore characterized by their hydrophilic-lipophilic balance (HLB). The HLB value is a quantitative measure of the overall hydrophilic nature of the surfactant at issue, wherein a higher HLB value means an increased hydrophilic character of the surfactant. According to certain implementations, the HLB value is advantageously in the range of from about 5 up to about 80, suitably in the range of from about 8 up to about 30, and the range of from about 10 up to about 20 may be preferred. Values of the HLB's for a large number of surfactants can be found in McCutcheon's, vol. 1, Emulsifiers and Detergents, North American Ed., 1993. Amphiphilic surfactants that are anionic may be preferred. A surfactant is a soluble sulfonated salt with an aliphatic tail, such as salts of alkyl sulfonic acid and alkyl sulfuric acid, e.g. sodium dodecyl sulfate (SDS) may be particularly preferred. Further included are salts of deoxycholic acid and cholic acid (such as sodium deoxycholate and sodium cholate).

The mole ratio of phosphate ion to metal ion (in the mixture of water soluble salt and surfactant) is from about 0.01 to about 0.50; from about 0.05 to about 0.4; or about 0.1 to about 0.35 may be the preferred mole ratio of precipitating agent to metal.

Suitable precipitating agents may include but are not limited to inorganic carbonate salts, oxalates, phosphate salts and inorganic iodides, such as potassium iodide. The preferred precipitating agent, according to certain implementations, includes a phosphate salt, mono-, di-, or tri-basic, such as sodium or potassium phosphate, and particularly tri-basic sodium phosphate. The precipitating agent includes a reaction product solubility so as to precipitate the metal onto the support and be non-toxic. The transition metal may be mounted on the polymeric support such as, for example, by means of a chemical metathesis reaction. Thus, for instance, where the water soluble salt may be silver nitrate, the precipitating agent may be a phosphate salt, and the metal mounted on the support may be silver phosphate.

Once the transition metal is mounted onto the support, the product may be heated to remove excess water. The dried material may be removed from the heat source and allowed to cool to room temperature. A reducing wash may be applied to reduce the metal precipitate to its elemental metal. The reducing wash may include an organic reductant in water. Suitable reductants include but are not limited to sodium borohydride, ascorbic acid, and sodium dithionite. The normal ratio of reductant to metal may range from about 0.01 to about 1.5 N; but may have a ratio of about 0.05 to about 1.1 N; or about 0.5 to about 1.0 N may be preferred.

After mixing the reductant with the metal/support, the solids may be decanted, then washed with de-ionized water. The volume of water for each wash may exceed the total volume of the solids. In some preferred embodiments, the volume of water in each wash exceeds two times the volume of the solids, and in some implementations, the volume of each wash may exceed three times the volume of the solids. The wash removes any residue of surfactant or precipitating agent from the supported metal composite.

The composite material is then isolated, such as by decantation or filtration, and allowed to dry, either in air or in heat. The solids may be dried in dry heat below 130-170° C. or lower such as at or below about 100° C. For instance, according to certain implementations, the product may be heated twice: once after precipitation, and once after reduction and washing. Any excess water used in the formation of the mixture is evaporated by heating the composite to about 130° C. or less. The water may be evaporated at a heat less than, but within 20° C., of the melting point of the support material. However, in other embodiments, a shaped solid form may be desired, and in this case the water may be evaporated at a temperature greater than the melting point of the support, e.g., within a mold, such as at less than 350° C.

The composite may have a total metal content of about 0.01 to about 10.0% (w/w basis). In some embodiments, the total metal content may be from about 0.04 to about 5.0% (weight basis); or about 0.1 to about 2.53 (w/w basis) may be preferred.

The composite differs in a number of ways from typical elemental metal deposition onto a support, such as is used in industrial catalysts. First, the transition metal is not catalytic in its action. The chemical antimicrobial action of the metal is part of a redox reaction and alters the chemical nature of the metal in the process.

Second, the deposited metal does not perform its principal chemical activity in situ on the support. Instead, the metal is intended to dissolve off of the support as the aqueous metal ion, and only then is it a suitable antimicrobial. Thus, the primary purpose of the support is to provide a high surface area platform that easily allows the introduction of a large number of very small, yet discrete, deposits of the metal into the reservoir or water processing machinery to be treated.

The processes of the present disclosure produce a large number of discrete loci of precipitated metal(s). It is the creation of this large number of externally exposed metal atoms, on each of the discrete depositions, that increases the solubility of the nano-deposited metal by at least two orders of magnitude over the solubility of the bulk metals. The relationship of decreased particle size and the increased rate of dissolution is reported in R. M. Cornell and U. Schwertmann, The Iron Oxides, VCH Publishers, NY, N.Y., 1996, pp 199-200 as well as D. Langmuir and D. O. Whittemore, In: Gould, R. F. (ed.) Nonequilibrium Systems in Natural Water Chemistry, Adv. Chem series 106, Am. Chem. Soc., Washington, D C, 1971, pp. 209-234. Bulk metal, such as that present in bars of silver, is not soluble even under some strongly corrosive conditions, and does not serve as an efficacious antimicrobial because it never becomes solvated as the highly redox-reactive ion. Other methods of metal deposition, such as plasma deposition, CVD, and high temperature evaporation, are not intended to maximize the number of discrete tiny metal deposits. As a result, a large proportion of the atoms of the deposited metals are surrounded/chemically protected by other metal atoms and behave as the bulk metal (or alloy, in the case of mixtures) with regards to solubility.

Aspects of the present disclosure maximize the number of small discrete deposits of metal on the support, thereby maximizing the thermodynamic free energy present at the surfaces of the deposit—by maximizing the proportion of metal atoms directly exposed to the solvent. It is the increase of thermodynamic surface free energy around each discrete metal deposit that provides the significantly improved antimicrobial action, as compared to the antimicrobial actions of the bulk metals, because the high free surface energy greatly increases the chemical reactivity of the deposited metals to oxidation and solvation.

In a particular example, silver nanoparticles and fine particles may be significantly more active and significantly more soluble than bulk silver, due to their increased surface to volume ratio and available free energy. The active antimicrobial action results from the generation of solubilized Ag+ ions that then can interact with microbes present in the environment. With non-coated small particles of Ag, the rate of dissolution necessarily changes as atoms are removed from the nano-particle and the particle becomes yet smaller and thereby increases its surface to volume ratio and available Gibbs free energy.

According to certain implementations, the metal particulates are coupled to the polymeric support by van der Waals forces. In further implementations, the antimicrobial composite may be subjected to a heat treatment to cause at least a portion of the polymeric support to melt and embed the metal particles onto the exterior surface of the support material. For instance, the support may have a melting point of about 86° C. to about 300° C. and be heating to or above the melting point for a period sufficient to enable the metal particles to partially embed in the polymer support material while leaving another portion of the particles exposed and available for delivering antimicrobial properties.

According to further implementations, generation of active metal ions, such as Ag+ ions, may additionally or alternatively be controlled over time to provide an antimicrobial composite with extended longevity. This control may be effected by the partial, i.e., non-complete, coverage of the metal particle using, for instance, a hydrophobic coating. In one example, a silver nanoparticle or fine particle deposited on the polymeric support may be coated to prevent and control dissolution. Coatings suitable for binding to the transition metals of the antimicrobial composites may include, but are not limited to, an R-silane coating, an R-quaternary ammonium coating, an R-phosphonate coating, an R-sulfonate coating, or an R-carboxylate coating, which couples to at least a portion of the exterior surface of the metal particle. The R group for these coatings may preferably be an alkyl or an alkene moiety, which can range from a methyl group up to and including an octadecyl group, branched or unbranched. The size of the alkyl group is determined by specific application and intended dissolution rate of the transition metal. In the example of a silver particle, the R group may also be of such nature that it sterically prevents the access of water to the portion of the silver particle to which the R group is bound such as, but not necessarily limited to, a tert-butyl group. The unattached end of the coating coupling may also contain an active chemical moiety that can be used to pre-condition the aqueous environment while it is being exposed to the active metal particle. For instance, in the example of using a silver antimicrobial composite, the moiety may be effective at removing or binding sulfur or phosphonate particles that may otherwise interfere with the action of Ag+ ions. Thus, the R group of any of the above couplings may consist of or contain at its end: methylsulfonate, ethylsulfonate, vinylsulfonate, propylsulfonate, isopropylsulfonate, butylsulfonate, hexylsulfonate, octylsulfonate, decylsulfonate, dodecylsulfonate, or octadecylsulfonate, isopropylsulfonate or isobutylsulfonate, phenylsulfonate, benzylsulfonate, xylylsulfonate, biphenylsulfonate, or naphthylsulfonate, methyltrimethylammonium, ethyltrimethylammonium, vinyltrimethylammonium, propyltrimethylammonium, butyltrimethylammonium, hexyltrimethylammonium, octyltrimethylammonium, decyltrimethylammonium, dodecyltrimethylammonium, or octadecyltrimethylammonium, phenylammonium, benzylammonium, xylylammonium, biphenylammonium, or naphthylammonium, phenyltrimethylammonium, benzyltrimethylammonium, xylyltrimethylammonium, biphenyltrimethylammonium, and naphthyltrimethylammonium, decyl, unidecyl, dodecyl, methyl, ethyl, propyl, tetryl, pentyl, hexyl, septyl, octyl, nonyl, octadecyl, dodecylsulfonate, octadecylsulfonate, phenylsulfonate, ethylammonium, hexylammonium, butyltrimethylammonium, or hexyltrimethylammonium. By applying a protective coating or coupling at least a portion of the metal particles of the antimicrobial composite with a protective layer, the particles are consumed more slowly over time because water is able to contact only the portion of the metal particle that is not coupled to or coated by the protective layer. Successive depletion of the exposed surface area of the particle leads to the eventual consumption of the metal particle, however, substantial consumption of the metal particle is over an extended period compared to unprotected metal particles. As provided herein, the particles may continue to be coupled to the support by van der Waals forces even when coated, however, the coating may bind to both the exterior surfaces of the particle and the support, thereby increasing strength of contact between particle and support. According to one example, the protective coating may be applied using a solution bath in which the coating binds to the metal and can be washed from the polymeric support.

Moreover, while other supported metal depositions typically seek to form thin, finely-dispersed layers of the metals upon the support as an ideal construct, the process of the present disclosure maximizes the irregular placement of separate and discrete loci of deposited metals on the support and provides a long-term supply of highly redox-reactive metal ions to act as an antimicrobial. In so doing, the process maximizes the solubility of otherwise nearly insoluble metals. It is the solvated metal ions that provide the primary antimicrobial action equivalent to that of silver nitrate or household bleach.

### Antimicrobial Composite—in Use:

When placed into an area to be treated, the support (or spheres or pellets thereof) is incapable of being disseminated from the container. The antimicrobial composite as a whole is thus incapable of being transferred or loosed into the bulk water. The porosity of the container is therefore dependent upon the size of the support of the antimicrobial composite, wherein the diameter of the pores of the outer layer are dependent and smaller than the diameter of the support of the antimicrobial composite.

Contact of the composite with oxygen dissolved in the water, as well as in the environmental air, causes oxidation and dissolution of the resultant metal oxide. Whenever the dissolved metallic ions encounter prokaryotic cells, the reduction of the metal strips the electrons out of the prokaryotic cell walls. The peptidoglycans of the cells are destroyed by oxidation, resulting in the destruction of cellular integrity. Some of the subsequently reduced metal atoms may deposit directly onto the walls and surfaces of the water reservoir.

Because these secondary depositions of metal are believed to be of exceedingly small size, e.g., 1 to 20 nm in diameter, the depositions have much greater free surface energy than can be found in bulk deposits, and are therefore much more reactive (susceptible to reoxidation). The metal in the nano-depositions is oxidizable by both exposure to oxygen in air and by dissolved oxygen in water. This reoxidation allows the solvation of the ions back into the water, where the metal ions may react once again with any microbes present, and thereby prolong the effective lifetime of the metal originally released. The result of this secondary oxidation/dissolution/reduction cycle is that metal ions are placed, through water entrainment, with almost single atom precision at exactly the locations where microbes might find purchase and begin to multiply.

Because its antimicrobial action is primarily dependent on the intrinsic redox properties of the metal(s), implementations of the present disclosure may be used in a variety of applications involving any sump or water reservoir, including both drinking water and industrial water applications. For instance, the antimicrobial composite may be positioned in ice machines, such as in the ice machine sump, to prevent and/or control microbial growth within the machine and microbial contamination of the ice. In a similar fashion, implementations of the present disclosure can be placed in the reservoir of commercial or industrial cooling towers, as well as in household toilet water reservoirs. The composite may also be inserted into a well reservoir or bladder, or may also be placed within the reservoirs of home water filtration devices, such as pitchers and candle filter purifiers. Implementations may also be placed in home icemakers, such as those built into refrigerators. Further, implementations of the present disclosure may be placed in the sump or reservoir of air conditioner units to prevent the growth of slime, mold, algae, and bacteria, such the genus Legionella, the pathogenic bacteria that cause Legionnaires' disease.

Implementations may further be placed within a cartridge, either loose, or it may be contained within a separate porous container. For example, the antimicrobial composite, with or without the porous container, may be contained in an in-line cartridge for municipal water purification or for home point-of-entry or point-of-use applications. In addition, implementations may be contained in an in-line cartridge for final sanitation of water from a reverse osmosis or UV system. The antimicrobial composite may further be contained in a cartridge used to purify water in canteens or single servings of water from natural or municipal sources.

Implementations of the present disclosure may further be included, either as part of a mixture or as a separate layer, in multi-purpose water treatment cartridges to treat storm water run-off as well as in cartridges intended to treat other possible water contaminants such as odor, flavor, metals, organics, and/or chlorine.

### Example

The following example illustrates an embodiment of the present disclosure. Other embodiments within the scope of the claims herein will be apparent to one skilled in the art from consideration of the specification and practice of the following implementation as disclosed herein.

Manufacture of the Antimicrobial Composite.

3.2 g of AgNO₃ was dissolved in 20 ml of deionized water. 0.1 g of sodium laurel sulfate (SLS) was dissolved in 100 ml of deionized water. The silver nitrate solution and 4 ml of the SLS solution was mixed with 100 g of food-grade granulated polyethylene (PE, 12-20 mesh). 2.4 g of Na₃PO₄.12H₂O was dissolved in 24 ml of deionized water and the solution was mixed into the PE mixture. The mixture was dried at 90° C. for 3 hours, then allowed to cool to room temperature.

1.6 g of ascorbic acid, USP grade, was dissolved in 380 ml of deionized water and mixed with the PE mixture. The mixture was then drained and washed twice with 380 ml of water. The resulting solids were dried at 90° C. for 4 hours.

140 g of the antimicrobial composite were placed in a mesh bag (approximately 2″×4″) created by heat-sealing the edges of a 4″×4″ piece of food-grade polyester mesh. The bag was then placed in the sump of a Hoshizaki ice machine (500 lb. daily capacity, in continuous operation for about 1½ years) for 26 weeks.

### Sampling Procedure and Results.

Samples were taken prior to addition of the bag containing the antimicrobial composite (Week 0), and once per week thereafter (Weeks 1-26). Ice samples were taken from ice frozen from the same ice-making cycle for which sump samples were taken. Samples were collected in sterile tubes, then 1.00 ml of the sample (the melt water, in the case of the ice cubes) was added to a sterile Petri dish containing R2A agar. The Petri dishes were then grown at room temperature for 7 days, and the resulting colonies were counted by hand. Units in the Table are in CFU/cc.

TABLE 1

| Week | Sump | Ice |
|---|---|---|
| 0 | 260 | 2900 |
| 1 | 54 | 175 |
| 2 | 3 | 136 |
| 3 | 8 | 87 |
| 4 | 12 | 11 |
| 5 | 16 | 126 |
| 6 | 4 | 118 |
| 7 | 17 | 241 |
| 8 | 9 | 137 |
| 9 | 21 | 12 |
| 10 | 14 | 119 |
| 11 | 8 | 87 |
| 12 | 23 | 11 |
| 13 | 16 | 121 |
| 14 | 15 | 10 |
| 15 | 56 | 544 |
| 16 | 1 | 98 |
| 17 | 32 | 182 |
| 18 | 18 | 146 |
| 19 | 61 | 119 |
| 20 | 21 | 137 |
| 21 | 78 | 226 |
| 22 | 3 | 183 |
| 23 | 2 | 173 |
| 24 | 131 | 282 |
| 25 | 56 | 312 |
| 26 | 41 | 33 |

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. An antimicrobial composite comprising particulates of at least one transition metal coupled to an exterior surface of a polymeric support.

2. The antimicrobial composite of claim 1, wherein the transition metal comprises silver.

3. The antimicrobial composite of claim 1, wherein the particulates range in size from 50 nm to 400 nm.

4. The antimicrobial composite of claim 1, wherein the total transition metal content is about 0.01% to about 10.0% (w/w basis).

5. The antimicrobial composite of claim 1, wherein at least a portion of the transition metal of the antimicrobial composite is covered by a porous coating of one or more of a R-silane coating, an R-quaternary ammonium coating, an R-phosphonate coating, an R-sulfonate coating, or an R-carboxylate coating, and wherein the R group is an alkyl or alkene moiety.

6. The antimicrobial composite of claim 5, wherein the alkyl or alkene moiety contains from a methyl group up to and including an octadecyl group, branched or unbranched.

7. The antimicrobial composite of claim 5, wherein the R group, at a free end that is uncoupled to the particulate, comprises: methylsulfonate, ethylsulfonate, vinylsulfonate, propylsulfonate, isopropylsulfonate, butylsulfonate, hexylsulfonate, octylsulfonate, decylsulfonate, dodecylsulfonate, or octadecylsulfonate, isopropylsulfonate or isobutylsulfonate, phenylsulfonate, benzylsulfonate, xylylsulfonate, biphenylsulfonate, or naphthylsulfonate, methyltrimethylammonium, ethyltrimethylammonium, vinyltrimethylammonium, propyltrimethylammonium, butyltrimethylammonium, hexyltrimethylammonium, octyltrimethylammonium, decyltrimethylammonium, dodecyltrimethylammonium, or octadecyltrimethylammonium, phenylammonium, benzylammonium, xylylammonium, biphenylammonium, or naphthylammonium, phenyltrimethylammonium, benzyltrimethylammonium, xylyltrimethylammonium, biphenyltrimethylammonium, and naphthyltrimethylammonium, decyl, unidecyl, dodecyl, methyl, ethyl, propyl, tetryl, pentyl, hexyl, septyl, octyl, nonyl, octadecyl, dodecylsulfonate, octadecylsulfonate, phenylsulfonate, ethylammonium, hexylammonium, butyltrimethylammonium or hexyltrimethylammonium.

8. The antimicrobial composite of claim 1, wherein the polymeric support is one or more of pellets, granules, strips, shreds, or powder.

9. The antimicrobial composite of claim 1, wherein the polymeric support has an average particle diameter of about 0.5 μm to about 2.5 cm.

10. The antimicrobial composite of claim 1, wherein the polymeric support comprises one or more of polyethylene or polypropylene.

11. A method of preparing an antimicrobial composite comprising at least one transition metal mounted onto an exterior surface of a polymeric support, comprising:
a. mixing an aqueous solution of a salt of a transition metal and a surfactant with the polymeric support;
b. precipitating the transition metal onto the polymeric support;
c. reducing the precipitated transition metal to the elemental state of the metal; and
d. removing moisture to provide the polymeric support with transition metal particulates.

12. The method of claim 11, wherein at least a portion of the particulates are silver particulates.

13. The method of claim 11, wherein the particulates range in size from about 50 nm to about 400 nm.

14. The method of claim 11, further comprising coating the particulates with one or more of a R-silane coating, an R-quaternary ammonium coating, an R-phosphonate coating, an R-sulfonate coating, or an R-carboxylate coating, wherein the R group is alkyl or alkene moiety.

15. The method of claim 14, wherein the alkyl or alkene moiety contains from a methyl group up to and including an octadecyl group, branched or unbranched.

16. The method of claim 14, wherein the R group, at a free end that is uncoupled to the particulate, comprises: methylsulfonate, ethylsulfonate, vinylsulfonate, propylsulfonate, isopropylsulfonate, butylsulfonate, hexylsulfonate, octylsulfonate, decylsulfonate, dodecylsulfonate, or octadecylsulfonate, isopropylsulfonate or isobutylsulfonate, phenylsulfonate, benzylsulfonate, xylylsulfonate, biphenylsulfonate, or naphthylsulfonate, methyltrimethylammonium, ethyltrimethylammonium, vinyltrimethylammonium, propyltrimethylammonium, butyltrimethylammonium, hexyltrimethylammonium, octyltrimethylammonium, decyltrimethylammonium, dodecyltrimethylammonium, or octadecyltrimethylammonium, phenylammonium, benzylammonium, xylylammonium, biphenylammonium, or naphthylammonium, phenyltrimethylammonium, benzyltrimethylammonium, xylyltrimethylammonium, biphenyltrimethylammonium, and naphthyltrimethylammonium, decyl, unidecyl, dodecyl, methyl, ethyl, propyl, tetryl, pentyl, hexyl, septyl, octyl, nonyl, octadecyl, dodecylsulfonate, octadecylsulfonate, phenylsulfonate, ethylammonium, hexylammonium, butyltrimethylammonium or hexyltrimethylammonium.

17. The method of claim 11, wherein the polymeric support comprises one or more of polyethylene or polypropylene pellets, granules, or powder.

18. The method of claim 11, wherein precipitating comprises adding an aqueous solution comprising one or more of the following precipitating agents: inorganic carbonate salts, oxalates, phosphate salts or iodide salts.

19. The method of claim 11, wherein the metal salt of the transition metal comprises a nitrate, fluoride, perchlorate or chlorate.

20. The method of claim 11, wherein reducing comprises adding a reducing agent comprising one or more of sodium borohydride, ascorbic acid or sodium dithionite.

21. An antimicrobial composite, comprising:
silver particles, a support and a coating,
wherein the silver particles range in size from 100 nm to 400 nm,
wherein the support is configured as a discrete particle with a diameter between about 0.5 and about 4.0 mm,
wherein the silver particles are coupled to an exterior surface of the support by van der Waals forces,
wherein a portion of the silver particles are partially covered by the coating, said coating comprising one or more of an, R-silane coating, an R-quaternary ammonium coating, an R-phosphonate coating, an R-sulfonate coating, or an R-carboxylate coating,
wherein the R group is an alkyl or alkene moiety, and
wherein another portion of the silver particles are free of the coating.
